(19) United States
(12) Patent Application Publication
(10) Pub. No.: US 2012/0079388 A1
(43) Pub. Date: Mar. 29, 2012

(54) SYSTEM AND METHOD OF USER SUBMITTED COMPETITION

(76) Inventor: Sergio Nunez, El Monte, CA (US)

(21) Appl. No.: 12/892,928

(22) Filed: Sep. 29, 2010

(51) Int. Cl. G06F 3/01

(52) U.S. Cl. 715/733

(57) ABSTRACT

A system and process for user submitted competition is disclosed. The system may include an electronic venue, a server coupled to the electronic venue, a network, and a processor coupled to the electronic venue and the processor. The electronic venue may be configured to display user submissions. The processor may be configured to present two or more user submissions matched against one another in a competition. The process may include displaying a plurality of user submissions in a competition on a host website and providing a voting mechanism for selecting one of the user submissions. A winner may be displayed based on the results of the voting mechanism.

### BACKGROUND OF THE INVENTION

The present invention generally relates to competitive promotions and more particularly, to providing a system and method of user submitted competition.

Aspiring artists and entrepreneurs may have a common obstacle in finding exposure for their talent or product. There may exist in the public, several undiscovered talents or ingenious products. One difficulty in obtaining proper exposure is the lack of locating the proper resources to promote oneself. Some aspiring artists attempt to directly submit their work to a promoter or an agent. However, aspiring artists may find it difficult to be placed in contact with a talent promoter capable of distributing performances to the right target markets or of even gathering a promoter's attention. Similarly, product makers may find it difficult to locate a proper or legitimate promotion service that may market the product to potential consumers. While the remaining discussion will focus on the plight of aspiring artists, it will be understood that inventors and other entrepreneurs may share analogous issues.

One reason for the difficulty in finding a promoter willing to give an aspiring talent a chance is the ability to evaluate the sheer number of would-be talents versus the number of promoters. Some promoters may be barraged by voluminous submissions and do not have the time to sort through each one. Additionally, the promoters may prematurely dismiss some submissions because the production quality of the submission is crude relative to the production of other submissions. One reason this may occur is because some talent is located in areas with few to no local professional services to contact.

One manner in which aspiring talent has achieved a measure of success is to audition for reality television shows, for example American Idol®. The wait to audition may consume the better part of one or more days and some aspiring artists may not be able to afford to take that much time off. The aspiring artists may audition through a preliminary series of levels in front of a panel of judges whose judgment may be based on part by targeting certain demographics and on part by the presentation level of the competitors. An elite number of competitors, typically about two dozen, may then be advanced and assisted with their presentation by the show. Competitors may then be eliminated one at a time based on a weekly vote by the viewing audience.

Some aspiring artists resort to self-promotion. For example, aspiring bands or singers sometimes produce their own album and sell or give it away at random to the public in hopes of being discovered. A more recent method includes using the internet to distribute home made videos on sites such as YouTube®.

On self submitted sites like the aforementioned, users submit a wide spectrum of production quality works. Viewers submit ratings for each video on a stand alone basis indicating roughly whether or not the video may be worth watching. For some submitters, the hope is that a submitted video gains word of mouth and goes viral. However, the ability to go viral can be manipulated by hacker programs and does not necessarily give credibility to the success or quality of the talent in the video.

As can be seen, there may be a need for a system and method of providing comparative competition among self submitted entries.

### SUMMARY OF THE INVENTION

In one aspect of the present invention, a process of providing an on-line competition is described. The process may include providing a host website. A plurality of user submissions configured for display on the host website may be received. A first user submission may be displayed in a competition against a second user submission on the host website. A voting mechanism may be provided configured to receive on or more votes for the first and second user submissions. Additionally, a winner of the competition may be displayed based on the received one or more votes.

In another aspect of the present invention, a method of promoting talent is described. The method may include providing a web based talent venue for a plurality of users. A voter based competition of a plurality of user submitted talent productions may be provided on the web based talent venue. One or more contacts to production services may be provided for assisting one or more of the user submitted talent productions on the web based talent venue. The plurality of user submitted talent productions may be received and the plurality of user submitted talent productions in the voter based competition may be displayed.

In still yet another aspect, system of providing voter based competition, comprises a server configured to receive viewer data from a network. The system also includes an electronic venue coupled to the server, the electronic venue configured to display video of user submissions from a plurality of users. Additionally, a processor may be coupled to the server, wherein the processor may be configured to match two or more of the user submissions against one another in competition, wherein the processor may be configured to tabulate votes from the viewer data for each respective user submission, wherein the processor may be configured to select a winner between the two or more user submissions based on the votes, and wherein the winner may be displayed on the electronic venue.

These and other features, aspects and advantages of the present invention will become better understood with reference to the following drawings, description and claims.

### BRIEF DESCRIPTION OF THE DRAWINGS

FIG. 1 is a block diagram illustrating an exemplary embodiment of a system in accordance with one aspect of the present invention;

FIG. 2 is a flowchart illustrating a competition process in accordance with one aspect the present invention;

FIG. 3 is a flowchart illustrating an exemplary embodiment of a competitor user's experience process in accordance with one aspect of the present invention;

FIG. 4 is a webpage screen illustrating an exemplary selection screen in accordance with one aspect of the process of FIG. 3;

FIG. 5 is a webpage screen illustrating another exemplary selection screen in accordance with one aspect of the process of FIG. 3;

FIG. 6 is a webpage screen illustrating an exemplary uploading mechanism in accordance with one aspect of the process of FIG. 3;

FIG. 7 is a flowchart illustrating an exemplary embodiment of a voter user's experience process in accordance with one aspect of the present invention;

FIG. 8A is a webpage screen illustrating an exemplary voting mechanism in accordance with one aspect of the process of FIG. 7;

FIG. 8B is a webpage screen illustrating an exemplary observation of a user submission in accordance with one aspect of the process of FIG. 7;

FIG. 9 is a flowchart illustrating an exemplary embodiment of a process of competition in accordance with one aspect of the present invention;

FIG. 10A is a webpage screen illustrating an exemplary competition format in accordance with one aspect of the present invention;

FIG. 10B is a webpage screen illustrating another exemplary competition format in accordance with one aspect of the present invention;

FIG. 10C is a webpage screen illustrating still yet another exemplary competition format in accordance with one aspect of the present invention; and

FIG. 11 is an enlarged view of the circle 11 of FIG. 10C.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, embodiments of the present invention generally provide a system and method of user submitted competition. Users may create a data file containing audio and/or video of an entry in the form of an electronic user submission. User submissions are entered for competition by competing users within categories and are voted upon by voting users within an electronic venue.

Thus, in one aspect, a venue and a process is provided where users are able to participate in self-promotion by creating entries (user submissions). The entries may be observed by the public, the success of which may be measured by an approval rating or popularity of the entry when compared to other entries within a category. In another aspect, a resource is provided where, for example, aspiring artists or entrepreneurs may be directed to professional services that may assist in the production or consult in producing a higher quality user submission. Additionally, methods of efficiently comparing relevant works or products and processing entries in large-scale competitions are illustrated.

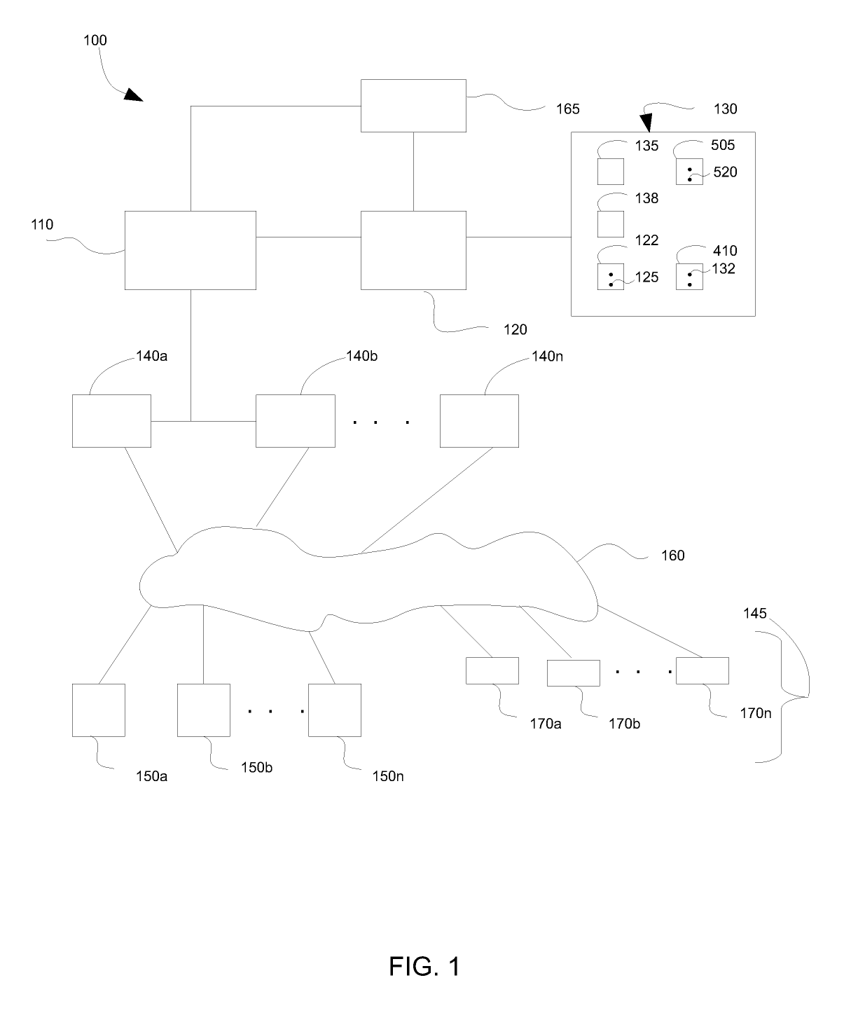

Referring now to FIG. 1, an exemplary system 100 for processing user submitted entries into a competition in accordance with one aspect of the present invention is shown. The system 100 includes an electronic venue 110, a processor 120, and one or more servers 140a, 140b to an infinite server 140n. The servers 140a, 140b to 140n may be software applications or may be one or more personal computers connected in series to the electronic venue 110. For ease of illustration, the servers 140a, 140b to 140n will be referred to generally as a server 140 in either the singular or plural tense interchangeably herein. The processor 120 may be a central processing unit (CPU) or a microprocessor and may reside externally of the electronic venue 110 or, in one exemplary embodiment, within one of the servers 140. A transceiver 165 may be coupled to the processor 120 and configured to transmit and receive messages from the processor 120 to the electronic venue 110.

A data processing module 130 may be coupled to the processor 120. The data processing module 130 may include either or both volatile or non-volatile memory storage. The data processing module 130 may include a storage module 122 storing a plurality of user submissions 125. In one exemplary embodiment, the processor 120 may evaluate the performance of individual user submissions 125 based on data received from data processing module 130. The data processing module 130 may include a user submissions module 132 accessing the user submissions 125. The user submissions module 132 may store one or more categories 410a to an infinite category 410n that are relevant to respective user submissions 125. For ease of illustration, use of the terms “category” or “categories” will be referred to in general as a category 410.

The data processing module 130 may also include a vote processing module 138 that may process the votes received for each user submission 125. The data processing module 130 may additionally include a competition results module 135 storing data related to matches of user submissions 125 and the results of voting for each of the user submissions 125 in each of the competitions held. Thus, the progression or cessation of a particular user submission in a competition may be evaluated by the processor 120 based on one or more pieces of data processed within the aforementioned sub-modules in the data processing module 130.

The data processing module 130 may further include a professional services directory 505 which may include a plurality of professional service contacts 520. The professional service contacts 520 may be predetermined to be relevant to providing one or more professional production services. In one aspect, the data processing module 130 may evaluate which professional service contacts may be relevant to one or more of the categories 410.

The user submissions 125 may be data files containing audio and/or video data presenting a talent based performance or a commercial product for evaluation to the viewing public. In one aspect, the user submissions 125 may include a musical component such as a digital music track or a recorded live performance of a musical instrument. Some examples of user submissions 125 including musical components may include singing performances, music videos, band performances, dance routines, show choirs, dramatic musicals, and operatic performances. In another aspect, the user submissions 125 may include an audio component without music. Some examples of user submissions 125 that include non-musical audio are dramatic recitations, skits, poetic recitations, animation, and stand up comedy routines. In another aspect, the user submissions 125 may include only video components. Some examples of non-audio submissions may include photographs, modeling portfolios, paintings, and sculptures. In still yet another aspect, the user submissions 125 may include a commercial product or other non-artistic item. For example, user submissions may include new products seeking market feedback. In another example, existing products may be submitted for comparison against similar products so the public may rate the products and share experiences for public view. Thus, the aforementioned examples may respectively represent a different category 410. While the aforementioned categories 410 represent some of the contemplated categories of competition, it will be understood that the present invention is not limited to these listed categories.

A plurality of users 145 are connected electronically to the electronic venue 110. The users 145 may be described by two classes; competitors 150a, 150b to infinite competitor 150n and voters 170a, 170b to infinite voter 170n. For ease of illustration, competitors 150a, 150b to 150n will herein be referred to in the singular or plural as a competitor(s) 150 and similarly the voters 170a, 170b to 170n as a voter(s) 170. Additionally, it will be understood that a competitor 150 may simultaneously also be a voter 170 if they are qualified to vote within a competition and vice versa. Furthermore, it will be understood that each of the users 145 has access to an electronic device configured to communicate either by hardwire or wirelessly to the electronic venue 110 and for ease of illustration, will be understood as representing both the user 145 itself and his or her chosen communication device. For example, a user 145 may be represented by their use of a personal computer, a portable computer, a cellular telephone, a personal digital assistant, or an electronic tablet.

The electronic venue 110 may be, an interactive platform connecting users 145 to data presented on the electronic venue 110 on an interactive screen. For example, the electronic venue 110 may be a host website displayed on a general purpose personal computer or a web based application stored on a hardware storage entity and displayed by video monitor. In one exemplary embodiment, users 145 may communicate with the electronic venue 110 by accessing a web-based application through a network environment 160. The network environment may include, for example, the internet, a wide area network, a cloud computing network, a hardwired network (for example, a cable system or a fiber optics network), or a wireless system (for example, a satellite or radio frequency system). In another exemplary embodiment, the electronic venue 110 may be an interactive screen presented by an audio/visual module system. The interactive screen may include graphical user components accessible by a control corresponding to the module system. Some examples of audio/visual module systems may include a monitor coupled to a gaming platform, a cable connection, or a satellite antenna system.

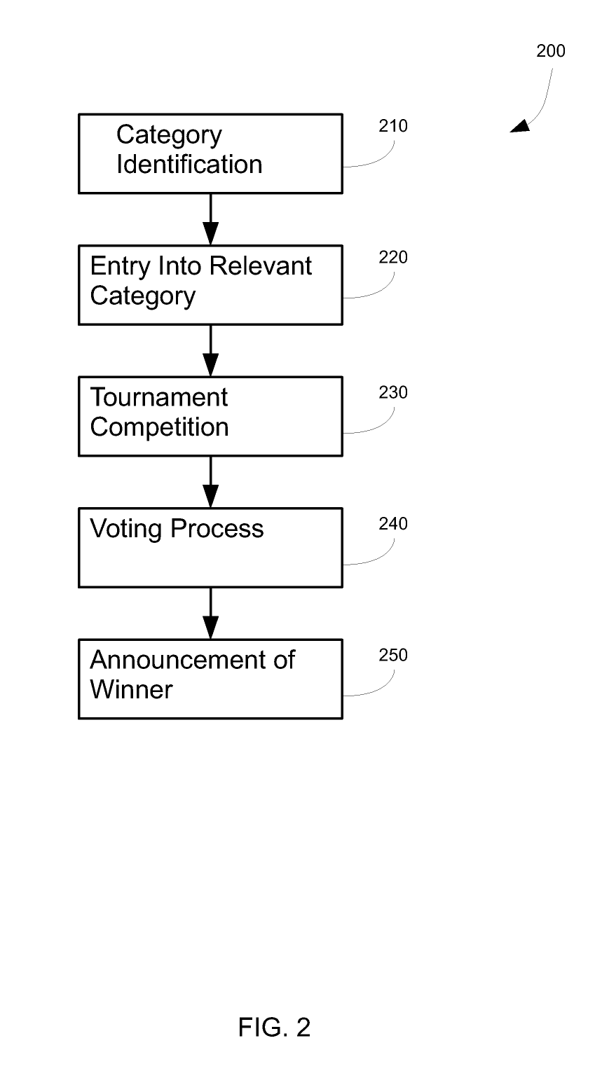

Referring now to FIG. 2 with concurrent reference to elements in FIG. 1, an exemplary competition process 200 is shown in accordance with one aspect of the present invention. In step 210, an appropriate category 410 is identified by a prospective competitor 150 based on the content of the competitor's user submission 125. The user submission 125 may be produced prior to identification of the category 410 or the user submission 125 may be produced once the competitor 125 locates a category 410 he or she wishes to compete within. In step 220, a finished user submission 125 is submitted for entry into the selected category 410. In some instances, a particular user submission 125 may include content relevant to multiple categories 410, and thus, may be entered into more than one category 410. For example, the user submission 125 may be a music video and may qualify for entry into a category 410 of singing performances, another category 410 of musical tracks, and another category 410 of special effects work. In step 230, the user submission 125 may be placed for observation in comparison to other user submissions 125. In one exemplary embodiment, the user submissions 125 compete against one another in a tournament format. In step 240, the voters 170 may vote for which user submissions 125 progress through a competition. Steps 230 and 240 may be repeated in sequence for multiple levels of competition. In step 250, the user submissions 125 winning their respective categories 410 may be announced.

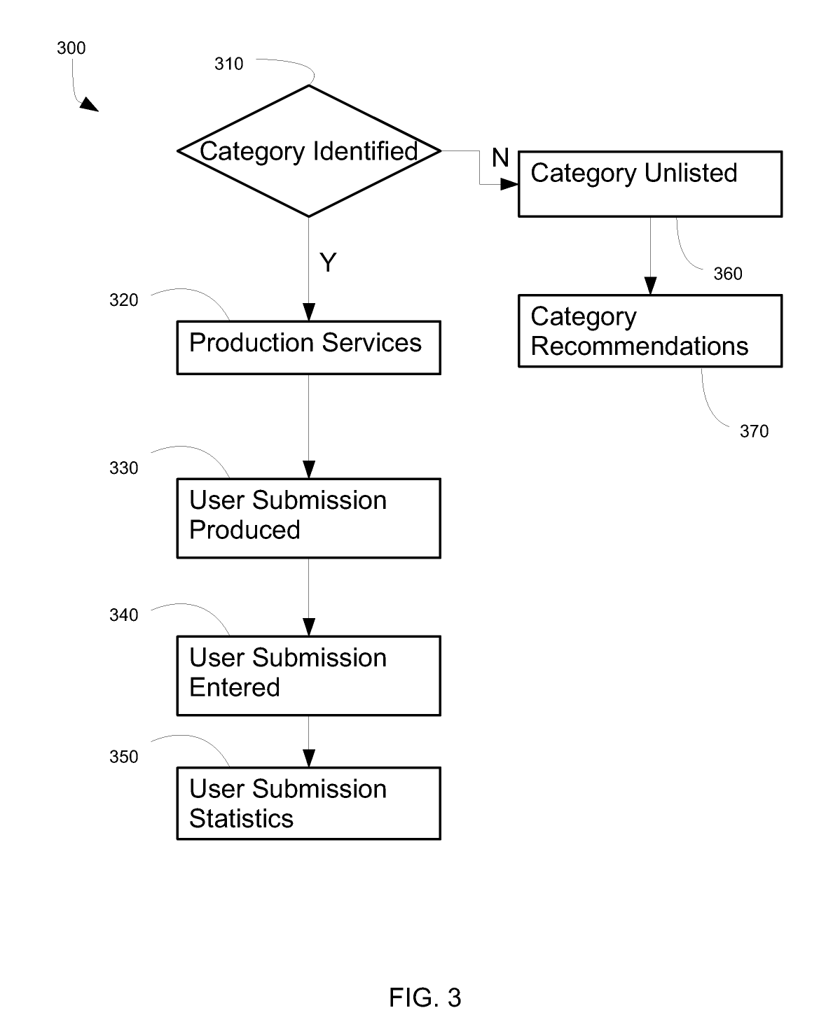

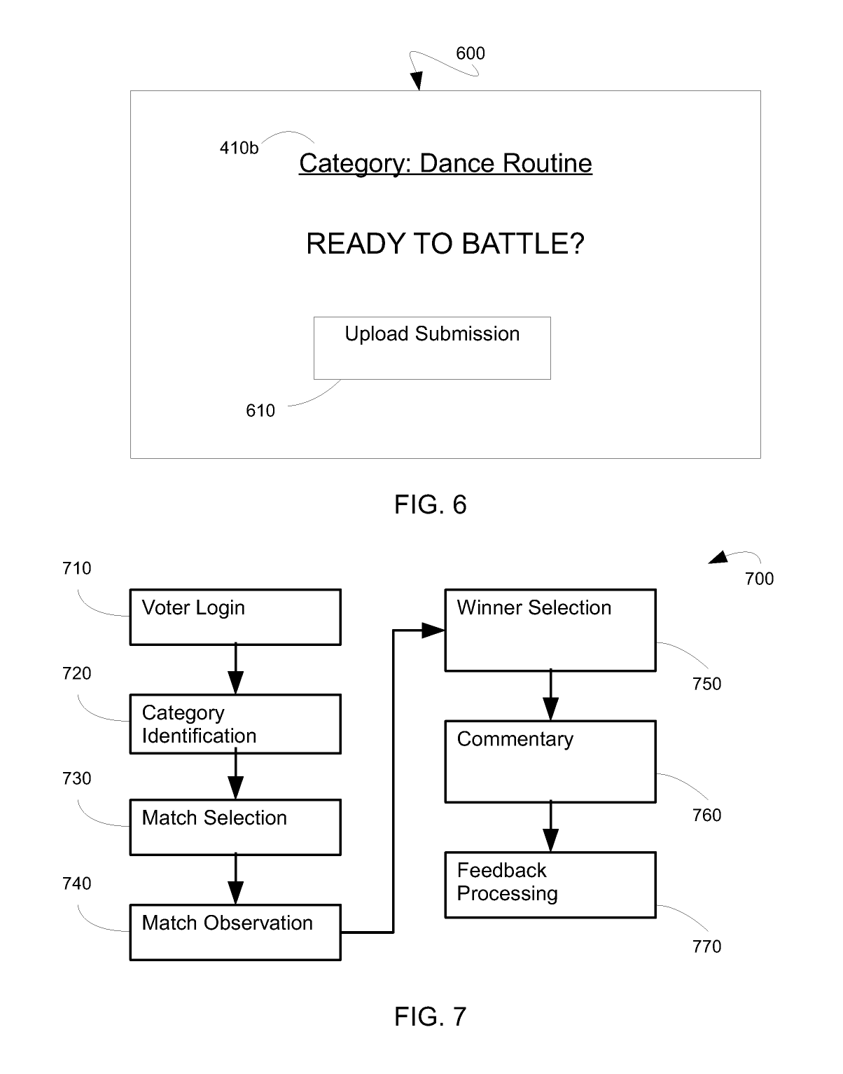

Referring now to FIGS. 3-6 with concurrent reference to elements in FIG. 1, an exemplary process 300 of submitting and competing with a self submitted user submission is shown in conjunction with exemplary interactive screens 400, 500, and 600 in accordance with one aspect of the present invention. In one exemplary embodiment, the interactive screens 400, 500, and 600 may be web pages.

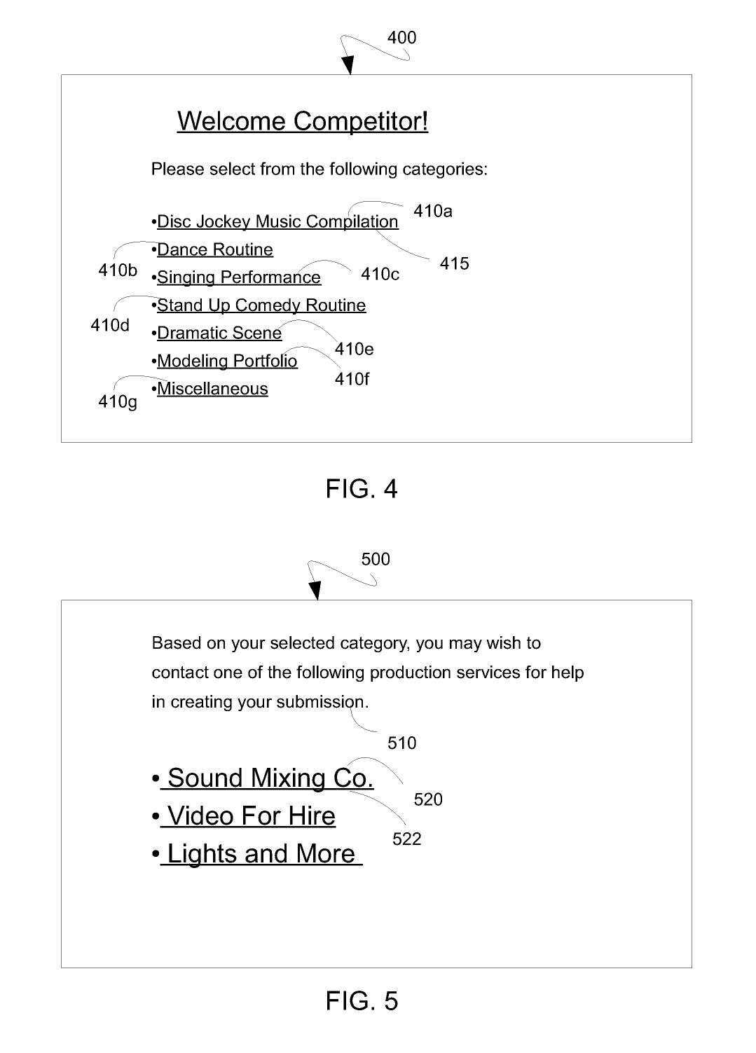

In step 310, a competitor 150 may identify a talent or product he or she possesses and wishes to promote and compete with on the electronic venue 110. Referring specifically to FIG. 4, a competitor may select from a screen 400 one of the categories 410a to 410g in which he or she wishes to compete within. Each of the categories 410a to 410g may include a hyperlink 415 directing the competitor 150 to an appropriate screen for signing up and/or submitting a user submission 125. While seven examples of categories are shown, it will be understood that many other choices may be made available. The competitor 150 may sign up to compete within a category 410 with or without a finished user submission 125.

In step 320, the competitor 150 may access the electronic venue 110 to seek one or more professional service contacts 520. In one exemplary scenario, the competitor 150 has not entered his or her user submission 125 yet. In one exemplary embodiment, the competitor 150 may voluntarily directly seek assistance in locating one or more professional service contacts 520 from. The electronic venue 110 may provide the competitor 150 access to the directory 505 of professional service contacts 520. Referring especially to FIGS. 4 and 5, in another exemplary scenario, the competitor 150 having selected a category 410, an interactive screen 500 may be provided. The interactive screen 500 may include a text box 510 including a message informing the competitor 150 that one or more professional service contacts 520 may be available for help based on the competitor's category 410 selection. The profession services contacts 520 displayed to the competitor 150 may include a hyperlink 522 retrieving additional information about the selected profession service contact 520.

Referring again to FIG. 3, in step 330, the user submission 125 may be produced. The competitor 150 may use any of the professional services associated with the professional services contacts 520 to assist in production of the user submission 125.

Referring especially now to FIGS. 3, 4, and 6, in step 340, the finished user submission 125 may be entered into competition into a selected category 410. The competitor 150 may be provided with the interactive screen 600 which may include a submission mechanism 610. In one exemplary embodiment, the submission mechanism 610 may be a selectable button prompting the competitor 150 to upload the file including the user submission 125.

Referring back to FIG. 3, in step 350, a competitor 150 may be provided with one or more statistics regarding his or her user submission 125. For example, the competitor 150 may be provided with statistics showing how many votes his or her user submission 125 has received, how many hits have been logged, how high the user submission 125 is ranking in one or more comparison lists, what kind of ratings have been given by voters 170, and what kind of feedback or comments have been recorded by the voters 170.

With continued reference to FIG. 3 and concurrent reference to elements in FIG. 1, step 360 may follow step 310 when a competitor 150 cannot find a category 410 applicable to the work or product he or she wishes to compete with. When this exemplary event occurs, the competitor 150, in step 370 may be provided with a user recommendation option. The competitor 150 may provide a suggested additional category 410 for consideration into future competitions. A threshold number of suggestions for the same type of suggested category 410 may be included onto the electronic venue 110 for competition. Thus, in one aspect, the users 145 may assist in developing relevant content for inclusion in the electronic venue 110 that may have immediate interest to the public.

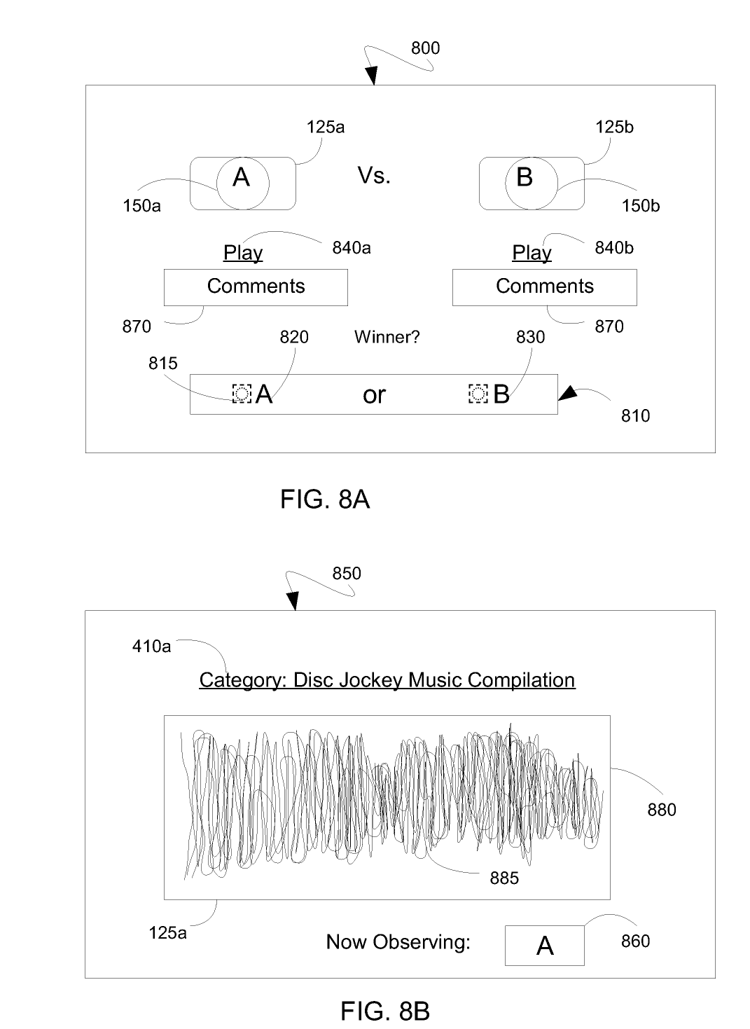

Referring now to FIGS. 7, 8A, 8B and with concurrent reference to elements in FIG. 1, a process showing an exemplary voter 170's experience is shown according to one aspect of the present invention. In step 710, a voter 170 may be provided a login screen on the electronic venue 110. The voter 170 may be prompted to supply a user name and password to verify his or her identity. Any actions taken by the voter 170 may be recorded for purposes that may include limiting the amount of times a particular user submission 125 may be voted on by that voter 170, evaluating feedback or comments provided by the voter 170 for either potential recommendations or for monitoring undesirable account usage, and for contacting the voter 170 for recommendations.

In step 720, the voter 170 may identify a category 410 in which he or she wishes to observe user submissions 125 that are in competition with one another.

Referring especially to FIGS. 7 and 8A, an interactive screen 800 may provide the voter 170 with a mechanism to select a matchup of competing user submissions 125, for example a user submission 125a versus a user submission 125b (step 730) which may be identified by either a title of a user submission or by name of the competitor (150a; 150b).

In step 740, the voter 170 may observe one or more of the user submissions 125 in the selected category 410 by selecting a link 840. In FIG. 8A, for example, selecting a link 840a may take the voter 170 to a separate screen or window where observation of the user submission 125a may occur and similarly, selecting a link 840b may take the voter 170 to observation of the user submission 125b.

Referring now especially to FIGS. 7 and 8B, an example of observing competing user submissions 125 is shown (step 740). FIG. 8B illustrates an exemplary interactive screen 850 for observation of the user submission 125a. In an exemplary embodiment, FIG. 8B illustrates a sound wave graphic 855 representing a musical track entered into the category 410a. The user submission 125a may be shown within a window 880 and an accompanying field 860 may identify the title of the user submission 125a.

Referring back now to FIGS. 7 and 8A, a voting mechanism 810 may be provided for selection of a winner in a competition (step 750). The voting mechanism 810 may include selection fields 820 and 830 representing competing user submissions 125a and 125b respectively. In one exemplary embodiment, the selection fields 820 and 830 may include radio buttons 815 that are selectable for registering a vote.

A text field 870 may provide a feedback or commentary entry from the voter 170 (step 760). While only one text field 870 is shown, it will be understood that a text field 870 may be tied to any of the user submissions 125 for associating a comment directly to a particular user submission. In one aspect, this may provide for ease of processing feedback (step 770) that may be used to modify the user experience and provide constructive feedback to the competitors (150a; 150b).

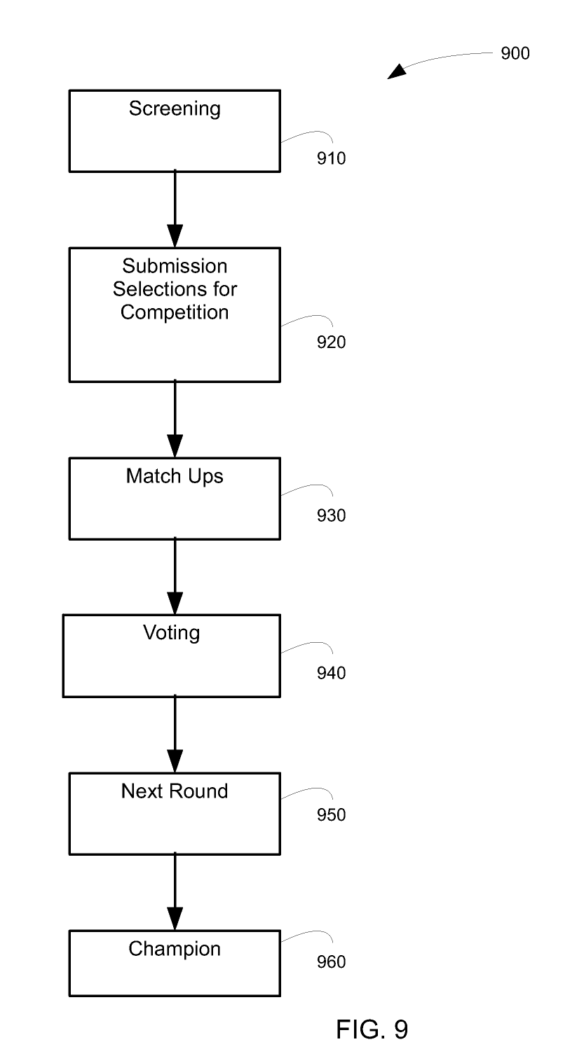

Referring now to FIG. 9, an exemplary competition process 900 is shown in accordance with one aspect of the present invention. In one aspect, a competition may be carried out in an on-line environment, for example, through the internet or another networked environment such as cloud computing. It may be anticipated that implementation of the present invention may attract a large-scale participation. Efficient processing of entries and competitions may benefit from one or more aspects of the present invention.

For example, in step 910, a screening step may be implemented. Screening may occur, for example, to verify that a user submission was entered into an appropriate category 410. The screening step may, in one exemplary embodiment, screen out inappropriate content uploaded onto the electronic venue 110 such as user submitted advertisements, unsolicited illicit material, and cyber bullying material. In another exemplary embodiment, the screening step may be used to pare down user submissions 125 within a particular category into a manageable volume presentable to the public. The paring down of user submissions 125 may be performed by weeding out poorly produced submissions because of visual/audio quality. In another exemplary embodiment, user submissions 125 that are permitted for competition may be screened out by a group of judges allowing a threshold number of entries to advance for observation within a category 410 (step 920).

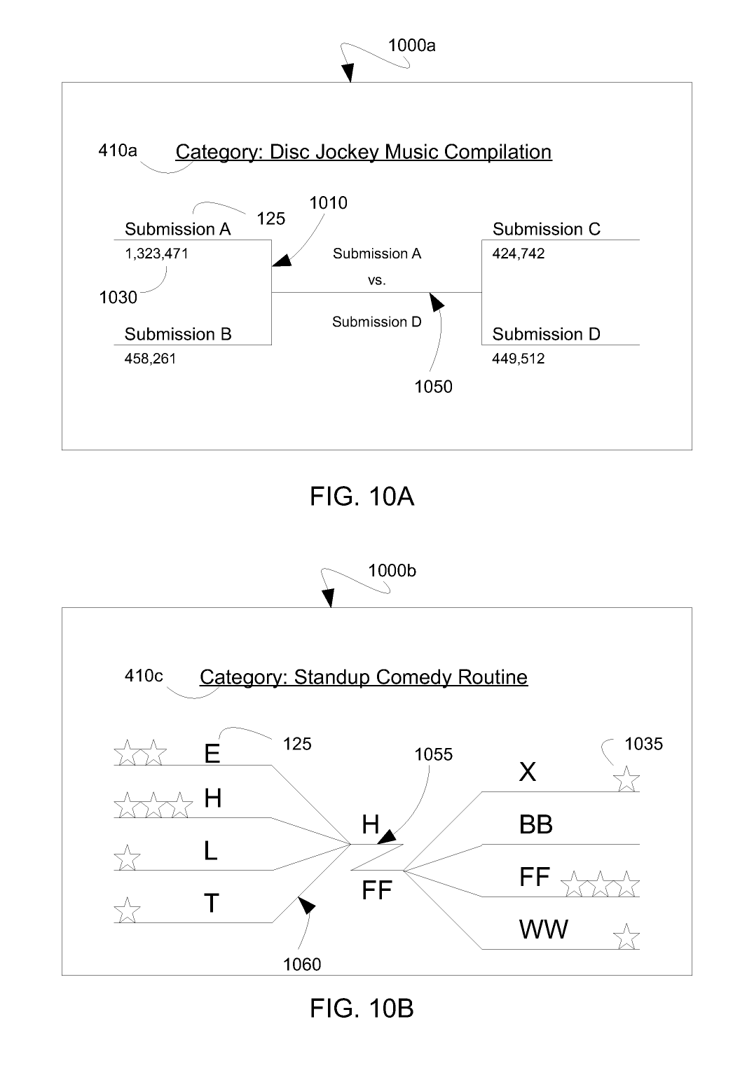

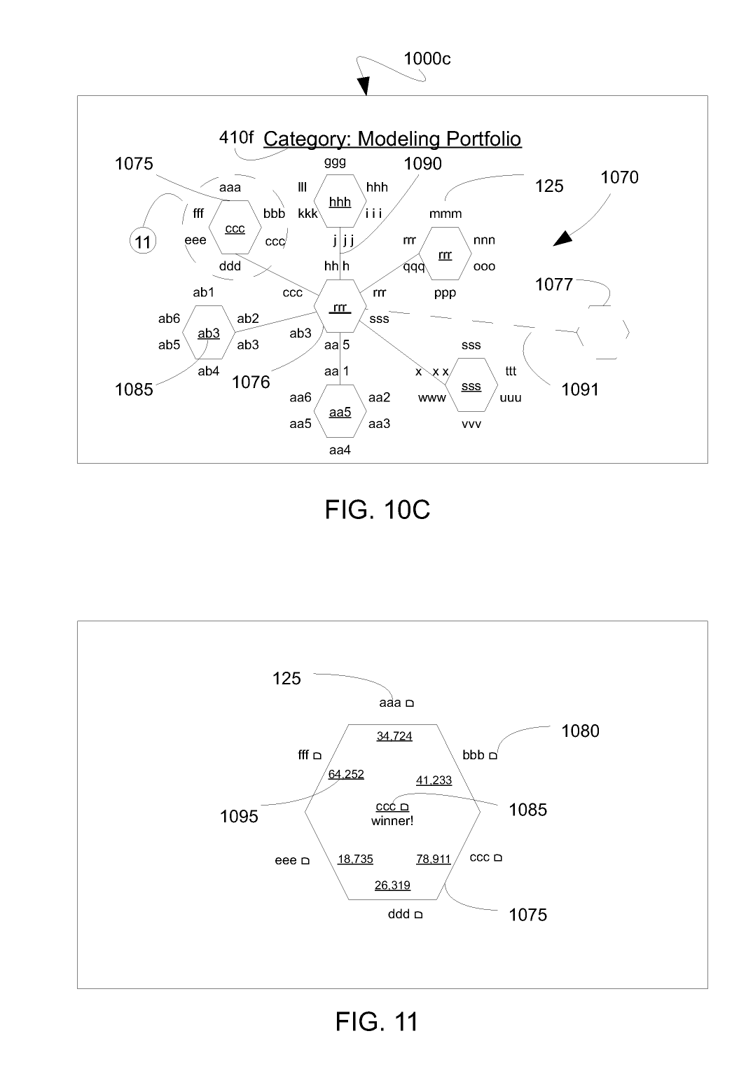

Referring still to FIG. 9 now concurrently with FIGS. 10A-10C and 11, an exemplary series of competition formats are shown. In step 930, user submissions 125 that will be presented for competition may be matched up against other user submissions 125 within the same category 410. Two or more user submissions may be matched up against one another by random selection or by a rating system. For example, during the screening process, an initial rating may be given to user submissions 125. In one exemplary embodiment, lower rated user submissions may be matched against higher rated user submissions.

In one exemplary embodiment, (FIG. 10A), a category 410a represents a disc jockey music compilation competition. An interactive screen 1000a shows user submissions 125 matched against one another in a head to head bracket 1010 format. In the exemplary bracket 1010 shown, the user submission 125 labeled Submission A receives more votes (shown in a voting results field 1030) than a matched up competing user submission 125 labeled Submission B (step 940). Likewise, the user submission 125 labeled Submission C receives fewer votes than its competitor user submission 125 labeled Submission D. In such an exemplary scenario, the user submission 125 labeled Submission A advances on to compete against the user submission 125 labeled Submission D in a sub-bracket 1050 (step 950). The winner of a final sub-bracket 1050 for a particular category 410 may be declared a champion (step 960).

In another exemplary embodiment, the volume of user submissions 125 may create more competitions than the viewing public may want to participate in. For example, if over sixty five thousand user submissions 125 are entered into a particular category, a voter 170 may end up observing the same particular user submission 125 about sixteen times during its succession through a tournament. Thus, in one exemplary embodiment, referring to FIG. 10B, an interactive screen 1000b is shown using a bunched bracket 1060 competition format within a category 410c for standup comedy routines. The bunched bracket 1060 may include three or more user submissions 125. In the exemplary embodiment shown, a star rating 1035 is used to determine the winner of each side of the bunched bracket 1060. In the exemplary embodiment shown, the user submission 125 labeled as “H” receives three full stars and advances to a sub-bracket 1055 including the user submission 125 labeled “FF” which received three stars on its side of the bracket 1060. While the sub-bracket 1055 is shown with two competing user submissions 125, in other words, the ones labeled “H” and “FF”, it will be understood that more than two user submissions 125 may be advanced into the sub-bracket 1055. Additionally, it will also be understood that ratings may include partial stars, for example, two and a half stars.

Referring especially now to FIGS. 100 and 11, in still yet another exemplary embodiment, an interactive screen 1000c is shown illustrating a competition within a category 410f of submitted modeling portfolios. In the exemplary embodiment shown, the category 410f has received voluminous amounts of acceptable user submissions 125 labeled “aaa”, “bbb”, and so on. The user submissions 125 may be grouped into a clustered bracket 1070. The clustered bracket 1070 may include multiple polygonal brackets 1075. In the exemplary embodiment shown, hexagonal shaped polygonal brackets 1075 are shown.

Referring especially to FIG. 11, an enlarged view of a polygonal bracket 1075 is shown. The polygonal bracket 1075 may include a tally field 1095 adjacent to a corresponding user submission 125 representing the voting results for each submission. The polygonal bracket 1075 may also include a graphic field 1080 that may include a picture representing the user submission 125 or may be a reduced screen image of the user submission 125. Additionally, the polygonal bracket 1075 may include a results field 1085 depicting the winner of a particular polygonal bracket 1075.

Referring back to FIG. 100 in general, the winners of respective polygonal brackets 1075 may be advanced into a sub-bracket 1076 shown as connected to respective polygonal brackets 1075 by lines 1090. Additionally, the winner of the sub-bracket 1076 may be advanced to another level of competition as illustrated by the shadow line 1091 connected to a shadowed polygonal bracket 1077.

It should be understood, of course, that the foregoing relates to exemplary embodiments of the invention and that modifications may be made without departing from the spirit and scope of the invention as set forth in the following claims.

I claim:

1. A process of providing an on-line competition, including:
providing a host website;
receiving a plurality of user submissions configured for display on the host website;
displaying a first user submission in a competition against a second user submission on the host website;
providing a voting mechanism configured to receive one or more votes for the first and second user submissions; and
displaying a winner of the competition based on the received one or more votes.

2. The process of claim 1, further including grouping the plurality of user submissions into a tournament format.

3. The process of claim 1, wherein the competition is displayed in a head to head format.

4. The process of claim 1, further including providing a feedback mechanism on the host website for receiving commentary on one or more of the plurality of user submissions.

5. The process of claim 1, wherein the plurality of user submissions are talent based submissions.

6. The process of claim 1, wherein the plurality of user submissions respectively include a musical component.

7. The process of claim 1, further including providing a plurality of categories of user submissions on the host website.

8. The process of claim 7, further including organizing the plurality of user submissions into the plurality of categories wherein the first user submission and the second user submission are both within a same category.

9. A method of promoting talent, including:
providing a web based talent venue for a plurality of users;
providing a voter based competition of a plurality of user submitted talent productions on the web based talent venue;
providing one or more contacts to production services for assisting one or more of the user submitted talent productions on the web based talent venue;
receiving the plurality of user submitted talent productions; and
displaying the plurality of user submitted talent productions in the voter based competition.

10. The method of claim 9, further including a plurality of talent categories on the web based talent venue wherein each of the user submitted talent productions is placed within one or more of the plurality of talent categories and wherein each of the plurality of talent categories is organized into a respective competition for two or more of the user submitted talent productions.

11. The method of claim 10, further including providing one or more suggested production services to one of the users based on the one or more of the plurality of talent categories the user's user submitted talent production is placed within.

12. The method of claim 10, further including providing a venue-wide competition wherein a winner from each respective talent category is selected and a first winner from a first talent category is matched in competition against a second winner from a second talent category.

13. The method of claim 9, further including providing the competition in a tournament style format.

14. The method of claim 9, wherein at least one of the plurality of user submitted talent productions includes a musical component.

15. A system of providing voter based competition, comprising:
a server configured to receive viewer data from a network;
an electronic venue coupled to the server, the electronic venue configured to display video of user submissions from a plurality of users; and
a processor coupled to the server, wherein
the processor is configured to match two or more of the user submissions against one another in competition,
wherein the processor is configured to tabulate votes from the viewer data for each respective user submission,
wherein the processor is configured to select a winner between the two or more user submissions based on the votes, and
wherein the winner is displayed on the electronic venue.

16. The system of claim 15 further comprising a transmitter coupled to the processor, wherein the processor is configured to identify production services relevant to a selected user submission and the processor is configured to transmit a message including the identified production services to the user of the selected user submission.
